(19) United States
(12) Patent Application Publication
(10) Pub. No.: US 2018/0093562 A1
(43) Pub. Date: Apr. 5, 2018

(54) VEHICLE LOWER STRUCTURE

(71) Applicant: TOYOTA JIDOSHA KABUSHIKI KAISHA, Toyota-shi (JP)

(72) Inventors: Toshio MURATA, Toyota-shi (JP); Yoshikazu Shinpo, Nissin-shi (JP); Yasuhiko Koda, Toyota-shi (JP); Hiromichi Sato, Nagoya-shi (JP)

(73) Assignee: TOYOTA JIDOSHA KABUSHIKI KAISHA, Toyota-shi (JP)

(21) Appl. No.: 15/674,761

(22) Filed: Aug. 11, 2017

(30) Foreign Application Priority Data
Sep. 30, 2016 (JP) 2016-195038

(51) Int. Cl. B60K 13/04; B62D 35/02; F01N 3/10

(52) U.S. Cl. CPC B60K 13/04; F01N 13/08; F01N 3/10; B62D 35/02

(57) ABSTRACT

There provided a vehicle lower structure including: an exhaust pipe which is disposed below a floor panel of a vehicle and in which an exhaust gas from an engine flows; an undercover that covers the exhaust pipe from below; and an inflow port that allows running air to flow into between the exhaust pipe and the undercover.

### CROSS-REFERENCE TO RELATED APPLICATION

This application is based on and claims priority under 35 USC 119 from Japanese Patent Application No. 2016-195038 filed Sep. 30, 2016, the disclosure of which is incorporated by reference herein.

### BACKGROUND

### Technical Field

The present disclosure relates to a vehicle lower structure.

### Related Art

In an underfloor structure of a vehicle, an underfloor section is configured by: an undercover that covers below an engine compartment; a floor panel of a vehicle interior; and a second undercover that covers below this floor panel (refer to, for example, Japanese Patent Application Laid-Open Publication No. 2011-235717).

In this structure, an exhaust system is arranged so as to extend in a front-rear direction along a central section in a vehicle width direction at a rear of the engine compartment, and a floor tunnel extends in a vehicle front-rear direction along this exhaust system.

Unevenness caused by an exhaust pipe on a lower side of the floor panel results in deterioration of aerodynamic performance during running. If, for example, below the exhaust pipe is covered by a flat cover in order to achieve an improvement in aerodynamic performance, there is a risk that heat accumulates between the exhaust pipe and the cover.

### SUMMARY

The present disclosure takes account of the above-described facts, and solves the problem of improving aerodynamic performance and suppressing accumulation of heat of an exhaust pipe.

A first aspect includes: an exhaust pipe which is disposed below a floor panel of a vehicle and in which an exhaust gas from an engine flows; an undercover that covers the exhaust pipe from below, and an inflow port that allows running air to flow into between the exhaust pipe and the undercover.

By an exhaust pipe disposed below a floor panel being covered from below by an undercover, a lower section of a vehicle can be more approximated to flatness and aerodynamic performance can be more improved, compared to in a structure not having the undercover.

During running of the vehicle, running air flows in from an inflow port to between the exhaust pipe and the undercover. Accumulation of heat of the exhaust pipe can be suppressed by this running air.

A second aspect provides the vehicle lower structure according to the first aspect, wherein the inflow port is formed in the undercover.

By the inflow port being formed in the undercover, the running air can be introduced directly to between the exhaust pipe and the undercover.

A third aspect provides the vehicle lower structure according to the second aspect, wherein: a catalytic converter that is configured to clean the exhaust gas is provided in the exhaust pipe; and the inflow port is formed under the catalytic converter or more to a front side of the vehicle than the catalytic converter.

An exhaust gas flowing along the exhaust pipe can cleaned by a catalytic converter. Since the inflow port is formed below the catalytic convener or more to a front side of the vehicle than the catalytic converter, accumulation of heat in a vicinity of the catalytic converter can be effectively suppressed by the running air, and the catalytic converter can be cooled.

A fourth aspect provides the vehicle lower structure according to any one of the first through third aspects, further including an inflow port shutter that is configured to open/close the inflow port.

Closing an inflow port shutter enables the lower section of the vehicle to be more approximated to flatness, in the case of not allowing the running air to flow into between the exhaust pipe and the undercover. Opening the inflow port shutter enables the running air to be allowed to flow into between the exhaust pipe and the undercover.

A fifth aspect provides the vehicle lower structure according to any one of the first through fourth aspects, further including an outflow port which is formed in the undercover on a side more to a rear of the vehicle than the inflow port and which allows the running air to flow out from between the undercover and the exhaust pipe to below the undercover.

A flow path of the running air can be formed by allowing the running air to flow out to below the undercover from an outflow port more to a vehicle rear side than the inflow port. Moreover, it can be suppressed that heat of air whose temperature has risen between the exhaust pipe and the undercover acts on a member more to a rear side of the vehicle than the outflow port.

A sixth aspect provides the vehicle lower structure according to the fifth aspect further including an outflow port shutter that is configured to open/close the outflow port.

Closing an outflow port shutter enables the lower section of the vehicle to be more approximated to flatness, in the case of not allowing the running air to flow out from between the exhaust pipe and the undercover. Opening the outflow port shutter enables the running air to be allowed to flow out from between the exhaust pipe and the undercover.

A seventh aspect provides the vehicle lower structure according to any one of the first through third aspects, further including: an inflow port shutter that is configured to open/close the inflow port, an outflow port which is formed in the undercover on a side more to a rear of the vehicle than the inflow port and which allows the running air to flow out from between the undercover and the exhaust pipe to below the undercover; and an outflow port shutter that is configured to open/close the outflow port in linkage with opening/closing of the inflow port by the inflow port shutter.

The outflow port shutter is linked to the inflow port shutter, hence, in a state where the inflow port is open, the outflow port is also open, and a flow path of the running air can be formed.

Since the present disclosure adopts the above-described configuration, aerodynamic performance can be improved and accumulation of heat of the exhaust pipe can be suppressed.

### BRIEF DESCRIPTION OF THE DRAWINGS

Exemplary embodiments of the present disclosure will be described in detail based on the following figures, wherein:

FIG. 1 is a cross-sectional view showing a vehicle lower structure of a first embodiment in a state where an inflow port shutter is closed;

FIG. 2 is a cross-sectional view showing the vehicle lower structure of the first embodiment in a state where the inflow port shutter is open;

FIG. 3 is a perspective view in which the inflow port shutter of the first embodiment in a closed state is seen from a vehicle lower side;

FIG. 4 is a perspective view is which the inflow port shutter of the first embodiment in an intermediate state is seen from a vehicle lower side:

FIG. 5 is a perspective view in which the inflow port shutter of the first embodiment in an open state is seen from a vehicle lower side;

FIG. 6 is a block diagram of the vehicle lower structure of the first embodiment;

FIG. 7 is a cross-sectional view showing a vehicle lower structure of a second embodiment in a state where an inflow port shutter and an outflow port shutter are open;

FIG. 8 is a cross-sectional view showing a vehicle lower structure of a third embodiment in a state where an inflow port shutter and an outflow port shutter are open;

FIG. 9 is a cross-sectional showing a vehicle lower structure of a fourth embodiment in a state where an inflow port shutter and an outflow port shutter are open;

FIG. 10 is a perspective view in which an inflow port shutter of a modified example in a closed state is seen from a vehicle lower side;

FIG. 11 is a perspective view in which the inflow port shutter of the modified example in an intermediate state is seen from a vehicle lower side; and

FIG. 12 is a perspective view in which the inflow port shutter of the modified example in an open state is seen from a vehicle lower side.

### DETAILED DESCRIPTION

A vehicle lower structure 12 of a first embodiment will be described with reference to the drawings. In the drawings, a front side of a vehicle is indicated by an arrow FR, an upper side of a vehicle is indicated by an arrow UP, and a width direction of a vehicle is indicated by an arrow W.

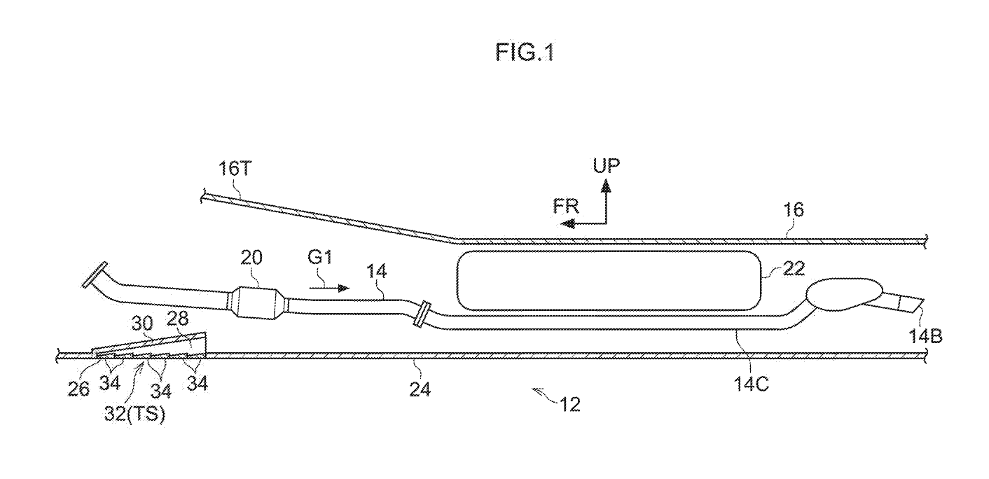

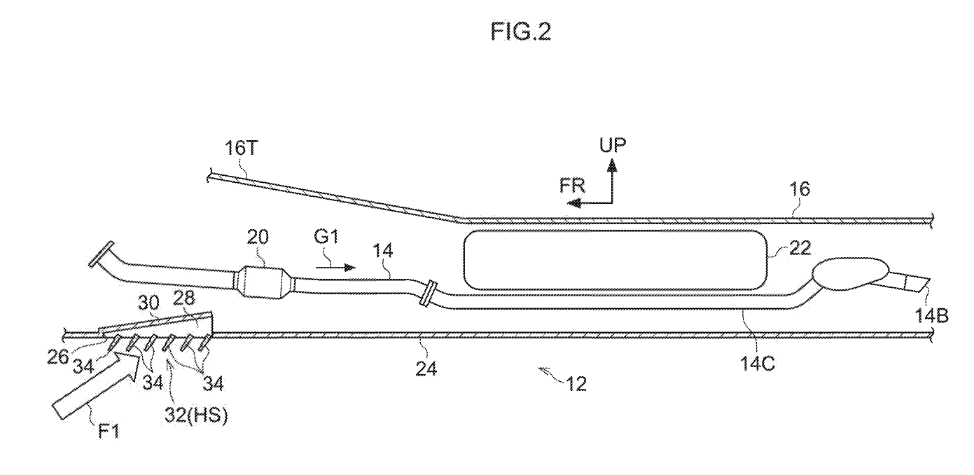

As shown in FIGS. 1 and 2, an exhaust pipe 14 is disposed below a floor panel 16 of a vehicle. In the present embodiment, at least part of the exhaust pipe 14 is extended in a front-rear direction of the vehicle.

A tunnel section 16T extending in a vehicle front-rear direction is formed in a center in a vehicle width direction of the floor panel 16. In the tunnel section 16T, the floor panel 16 is bent convexly in an upward direction. In the floor panel 16, a part where the tunnel section 16T is not formed that is, a portion on both sides in the vehicle width direction of the tunnel section 16T is an ordinary section. Moreover, a portion in the vehicle front-rear direction, for example, a portion extending in the front-rear direction of the vehicle, of the exhaust pipe 14 is housed in the tunnel section 16T.

One end in a longitudinal direction of the exhaust pipe 14 is connected to an unillustrated engine of the vehicle. An exhaust gas generated by the engine flows along the exhaust pipe 14 and is emitted to outside from another end 14B in the longitudinal direction of the exhaust pipe 14. In the drawings, a flow direction of the exhaust gas is indicated by an arrow G1. Hereafter, when simply “upstream” and “downstream” are mentioned, these mean, respectively, upstream and downstream of a flow of this exhaust gas.

A catalytic converter 20 is provided along the way of the exhaust pipe 14. When the exhaust gas passes through the catalytic converter 20, a specific substance in the exhaust gas is removed, and the exhaust gas is cleaned.

A fuel tank 22 is disposed more to a vehicle rear side than the catalytic converter 20. In the present embodiment, an up-down position of the fuel tank 22 is between the floor panel 16 and the exhaust pipe 14. The exhaust pipe 14 has formed therein a bent section 14C which is bent downwardly so as to avoid the fuel tank 22.

An undercover 24 is disposed on a lower side of the exhaust pipe 14, and is attached to the floor panel 16 by an unillustrated attaching member, for example. The undercover 24 is a member which is formed in a flat plate shape and covers the lower side of the exhaust pipe 14. The undercover 24 results in flatness of the lower side of the exhaust pipe 14 being higher compared to in a structure not having the undercover 24. The undercover 24 can be fixed bridging the ordinary sections of the floor panel 16, for example. A height of the undercover 24 need not be a height identical to that of the ordinary section of the floor panel 16. However, if a lower surface of the flatly shaped undercover 24 is made flush with a lower surface of ordinary section, flatness of the lower sale of the exhaust pipe 14 is high.

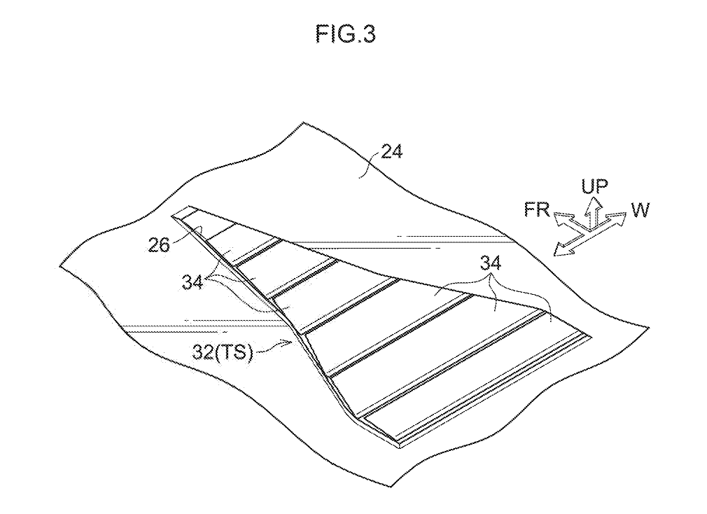

An inflow port 26 is formed in the undercover 24 at a position more to a front side of the vehicle than the catalytic converter 20. In the present embodiment, as shown in detail in FIGS. 3 to 5, the inflow post 20 has a substantially trapezoidal shape when viewed from below, and a width W1 of the inflow port 26 gradually increases from the front sale to a rear side of the vehicle.

A side wall 28 is erected in an upward direction in the vehicle width direction of the inflow port 26. Furthermore, an upper plate 30 is formed on an upper section of the side wall 28. A height of the side wall 28 increases linearly from the front side to the rear side of the vehicle, and the upper plate 30 inclines such that its vehicle rear side is higher than that of the undercover 24.

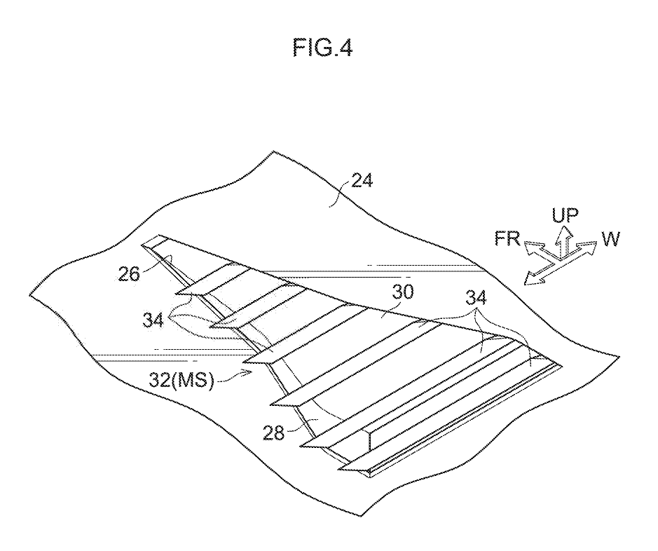

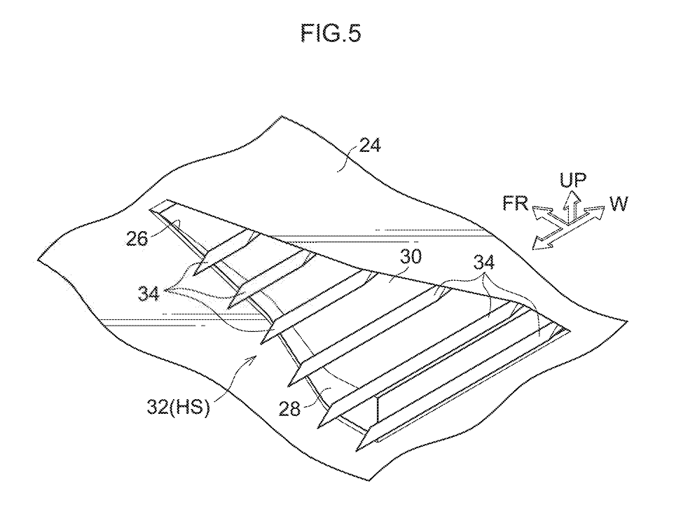

An inflow port shutter 32 is provided below the inflow port 26. The inflow port shutter 32 can adopt states passing from a closed state TS shown in FIG. 3 through an intermediate state MS shown in FIG. 4 to an open state HS shown in FIG. 5.

As shown in FIG. 2, in the open state HS of the inflow port shutter 32, at a running time of the vehicle, running air passes through the inflow port 26 from below the undercover 24 and flows into between the exhaust pipe 14 and the undercover 24. As shown in FIG. 1, in the closed state TS of the inflow port shutter 32, running air passing through the inflow port 26 is suppressed, and flatness of a lower surface side of the undercover 24 increases. In the intermediate state MS of the inflow port shutter 32, running air does pass through the inflow port 26, but an air amount that passes is less that at a time of the open state HS.

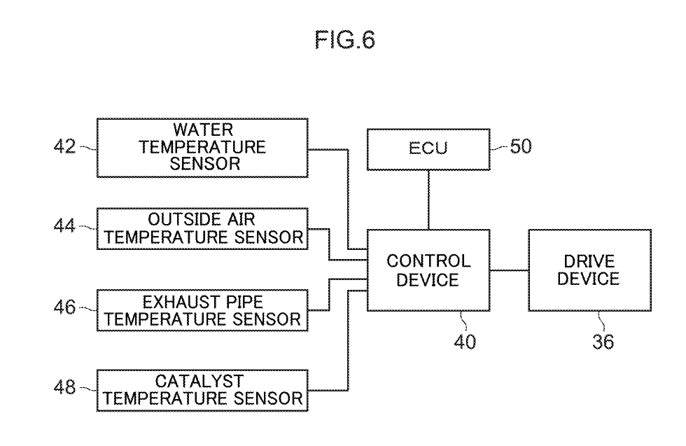

In the first embodiment, the inflow port shutter has a structure including plural flaps 34. The respective flaps 34 are joined by unillustrated linkage, and have identical inclination angles rotating around their shafts. As shown in FIG. 6, an inclination angle (an angle from the open state HS to the closed state TS) of the inflow port shutter 32 is adjusted by a drive device 36.

Particularly in the present embodiment, inclination of the flap 34 when the inflow port shutter 32 is in the open state HS tends to rise from the vehicle front side to the vehicle rear side. Therefore, as shown by an arrow F1 in FIG. 2, the present embodiment displays an action that running air flowing along a lower side of the undercover 24 is guided to an upper side of the undercover 24.

As shown in FIG. 6, the drive device 36 is controlled by a control device 40. The control device 40 has the following connected to it, namely, a water temperature sensor 42, an outside air temperature sensor 44, an exhaust pipe temperature sensor 46, a catalyst temperature sensor 48, and an engine control unit (ECU) 50.

The water temperature sensor 42 detects a temperature of engine cooling water. The outside air temperature sensor 44 detects an outside air temperature. The exhaust pipe temperature sensor 46 detects a temperature of a periphery of the exhaust pipe 14. The catalyst temperature sensor 48 detects a temperature of a catalyst carrying body (substantively a temperature of a catalyst) of the catalytic converter 20.

Furthermore, the control device 40 is configured such that data of a running history (running time, amount of exhaust gas, fuel consumption amount, and so on) or positional information of the vehicle is obtained from various kinds of devices of the vehicle. Moreover, the control device 40 controls the drive device 36 based on data obtained from these sensors or various kinds of devices.

A drive device having a structure that employs the likes of, for example, a motor or solenoid may be cited as the drive device 36. When a motor or solenoid is employed as the drive device 36, control of the inflow port shutter and an outflow port shutter based on the above-described various kinds of control factors, is easy.

Next, action of the present embodiment will be described.

In the vehicle lower structure 12 of the present embodiment, as shown in FIGS. 1 and 2, the undercover 24 is disposed below the exhaust pipe 14. In the present embodiment, the undercover 24 results in flatness of the lower surface of the undercover 24, that is, a vehicle lower section, being higher compared to in a structure not having the undercover 24. Therefore aerodynamic performance of the vehicle is also higher compared to in a structure not having the undercover 24.

The inflow port 20 is formed in the undercover 24. By allowing running air to flow into between the undercover 24 and the exhaust pipe 14 from the inflow port 26 during running of the vehicle, the exhaust pipe 14 can be cooled.

Since the inflow port is formed more to the front side of the vehicle than the catalytic converter 20, the catalytic converter 20 can be effectively cooled.

Note that depending on a shape of the inflow port 26, it sometimes also happens that much of the running air flows to directly above the inflow port 26, and in this case, the inflow port may be provided below the catalytic converter 20.

The inflow port shutter 2 is provided in the inflow port 26. As shown in FIGS. 2 and 5, assuming the inflow port shutter 32 to be in the open state HS, the running air is allowed to flow into between the undercover 24 and the exhaust pipe 14 from the inflow port 26, whereby the exhaust pipe 24 or the catalytic converter 20 can be cooled. As shown in FIGS. 1 and 3, assuming the inflow port shutter 32 to be in the closed state TS, flatness of the lower surface of the undercover 24 is more increased.

The inflow port shutter 32 is opened/closed by the control device 40 controlling the drive device 36. Examples shown in Table 1 below may be cited as specific control factors of the drive device 36 and their effects.

TABLE 1

| | | State of | |
|---|---|---|---|
| | | inflow port | |
| Control factor | | shutter | Effect |
| Temperature | Low | Closed | Aerodynamic characteristics |
| of engine | | | improved when temperature of |
| cooling | | | engine cooling water is low |
| water | High | Open | Exhaust pipe cooled when |
| | | | temperature of engine cooling |
| | | | water is high |
| Temperature | Low | Closed | Aerodynamic characteristics |
| of periphery | | | improved when temperature of |
| of exhaust | | | periphery of exhaust pipe is low |
| pipe | High | Open | Exhaust pipe cooled when |
| | | | temperature of periphery of |
| | | | exhaust pipe is high |
| Drive and | Stop | Closed | Aerodynamic characteristics |
| stop of | | | improved during engine stop |
| engine | Drive | Open | Exhaust pipe cooled during |
| | | | engine drive |
| Temperature | Low | Closed | Temperature rise of catalyst |
| of catalyst | | | promoted and aerodynamic |
| | | | characteristics improved when |
| | | | temperature of catalyst is low |
| | High | Open | Exhaust pipe cooled when |
| | | | temperature of catalyst is high |
| Cumulative | Small | Closed | Aerodynamic characteristics |
| fuel | | | improved when cumulative fuel |
| consumption | | | consumption amount is small |
| amount after | Large | Open | Exhaust pipe cooled when cumulative |
| engine start | | | fuel consumption amount is large |
| Outside air | Low | Closed | Water condensation in exhaust pipe |
| temperature | | | suppressed and aerodynamic |
| | | | characteristics improved when |
| | | | outside air temperature is low |
| | High | Open | Exhaust pipe cooled when outside |
| | | | air temperature is high |

For example, when the temperature of the engine cooling water is low, a temperature of the exhaust gas, that is, the exhaust pipe 14 is judged to also be low and the inflow port shutter 32 is set to the closed state TS, whereby aerodynamic characteristics of the vehicle are improved. In contrast, when the temperature of the engine cooling water is high, the temperature of the exhaust gas is judged to also be high and the inflow port shutter 32 is set to the open state MS, whereby the exhaust pipe 14 is cooled.

Furthermore, vehicle speed of the vehicle may be added to the control factors. In this case, it is possible to, for example, create a control map that controls a state of the inflow port shutter 32, from the temperature of the catalyst and the vehicle speed and, based on this control map, achieve a balance between aerodynamic characteristics of the vehicle and cooling (suppression of accumulation of heat) of the exhaust pipe 14.

It is also possible for control factors of opening/closing of the inflow port shutter 32 to be set combining two or more of each of the above-described control factors.

Next, a second embodiment will be described. In the second embodiment, elements, members, and so on, similar to those of the first embodiment will be assigned with identical symbols to those assigned in the first embodiment, and detailed descriptions thereof will be omitted.

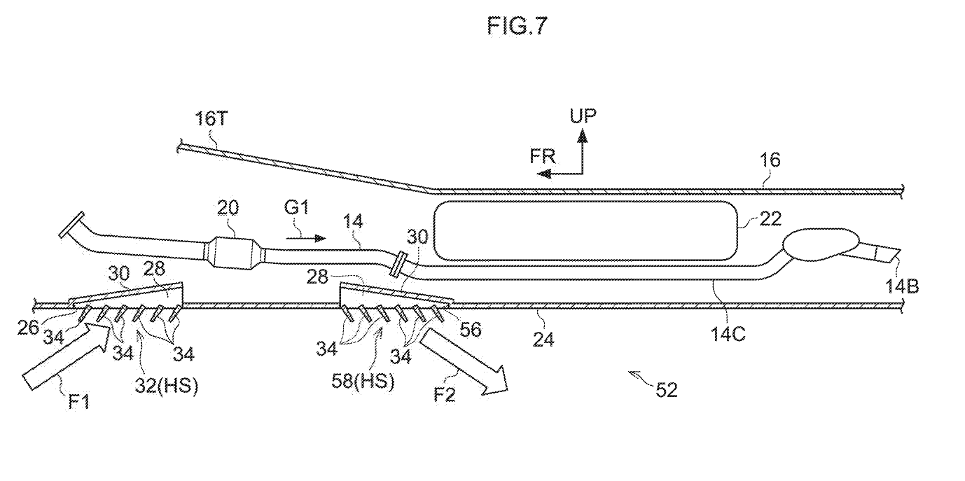

In a vehicle lower structure 52 of the second embodiment, as shown in FIG. 7, an outflow port 56 is formed, more to the vehicle rear side than the inflow port 26, in the undercover 24. In the example shown in FIG. 7, a position of the outflow port 56 is more to the vehicle rear side than the catalytic converter 20 and more to the vehicle front side than the fuel tank 22.

The outflow port 56 has a substantially trapezoidal shape when viewed from below, the side wall 28 is erected in an upward direction in the vehicle width direction of the outflow port 56, and the upper plate 30 is formed on an upper section of the side wall 28. Moreover, an outflow port shutter 58 is provided below the outflow port 56. That is, structures of the outflow port 56 and the outflow port shutter 58 are front-rear symmetrical to those of the inflow port 26 and the inflow port shutter 32.

Opening/closing of the outflow port shutter is driven by the drive device 36 (refer to FIG. 6). Particularly in the present embodiment, the outflow port shutter 58 is linked to the inflow port shutter 32. As shown in FIG. 7, when the inflow port shutter 32 is in the open state HS, the outflow port shutter 58 is also in the open state HS. In contrast, when the inflow port shutter 32 is in the closed suite TS, the outflow port shutter 58 is also in the closed state TS.

In the second embodiment, when the inflow port shutter 32 and the outflow port shutter 58 are both set to the open state HS, a flow path of the running air is formed. This flow path is a flow path by which the running air passes through the inflow port 26 from below the undercover 24 to flow into between the undercover 24 and the exhaust pipe 14 (refer to arrow F1), and flows out to below the undercover 24 from the outflow port 56 (refer to arrow F2).

By forming the flow path of the running air by the inflow port 26 and the outflow port 56 in this way, the exhaust pipe 14, particularly the catalytic converter 20, can be effectively cooled.

The outflow port 56 is formed more to the front side of the vehicle than fuel tank 22. Since the running air that has received heat from the catalytic converter 20 flows out to below the undercover 24 from the outflow port 56, action of heat of this running air on the fuel tank 22 is suppressed.

Next, a third embodiment will be described. In the third embodiment, elements, members, and so on, similar to those of the first embodiment or the second embodiment will be assigned with identical symbols to those assigned in the first and second embodiments, and detailed descriptions thereof will be omitted.

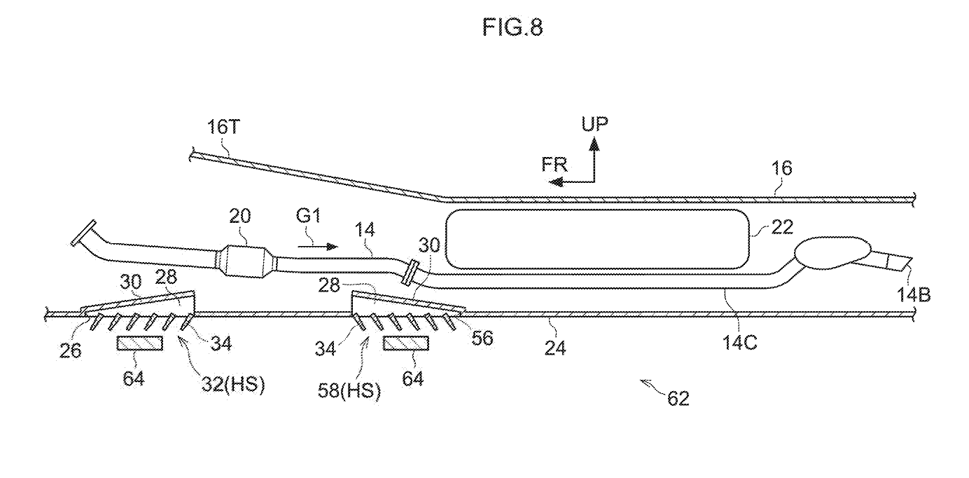

In a vehicle lower structure 62 of the third embodiment, as shown in FIG. 8, a vehicle structural member 64 is positioned below the inflow port shutter 32 and the outflow port shutter. The vehicle structural member 64 is a member configuring part of the vehicle, and, for example, a vehicle skeletal member (the likes of a cross member or brace) by which the floor panel 16 is bridged on both sides in the vehicle width direction of the tunnel section 16T, may be cited. The vehicle structural member 64 has a position and shape that do not affect an opening/closing operation of the inflow port shutter 32 and the outflow port shutter 58 and do not affect the flow of running air in the inflow port 26 and the outflow port 56.

In the third embodiment, since the vehicle structural member 64 is positioned below the inflow port shutter 32 and the outflow port shutter 58, the inflow port shutter 32 and the outflow port shutter 58 can be protected from foreign matter, and the like. For example, during running of the vehicle, sometimes, the likes of small stones or snow of a road surface jump up, and it can be suppressed that the inflow port shutter 32 and the outflow port shutter are damaged by these.

Next, a fourth embodiment will be described. In the fourth embodiment, elements, members, and so on, similar to those of the first through third embodiments will be assigned with identical symbols to those assigned in the first through third embodiments, and detailed descriptions thereof will be omitted.

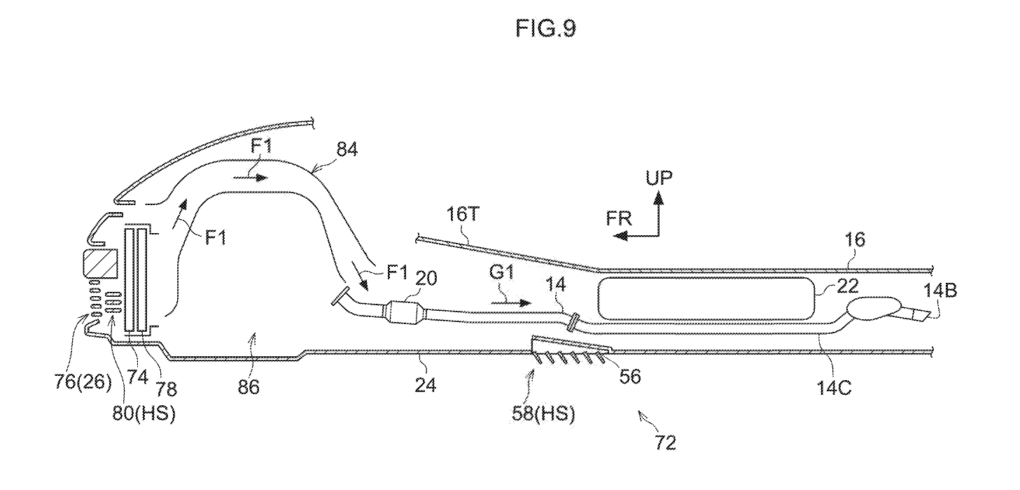

In a vehicle lower structure 72 of the fourth embodiment, as shown in FIG. 9, a grill is included in front of a radiator 74 of the vehicle. In the fourth embodiment, the grill 76 has a structure serving also as the inflow port 26. A radiator fan is disposed on the vehicle rear side of the radiator 74, and by driving the radiator fan 78, air can be introduced from the grill 76 and sent to the radiator 74.

A grill shutter 80 is provided in the grill 76. The grill shutter 80 is an example of the inflow port shutter 32. The grill shutter 80 is controlled by the control device 40 (illustration of which is omitted in FIG. 9; refer so FIG. 6), and can adopt the open state and the closed state. Opening/closing of the grill shutter 80 and opening/closing of the outflow port shutter 58 are linked.

An air guide path 84 is arranged more to the rear side of the vehicle than the radiator fan 78. In the example shown in FIG. 9, the air guide path curves above an engine compartment 86, and an end section on the vehicle rear side of the air guide path 84 opens into between the floor panel 16 and the exhaust pipe 14. That is, there is a structure in which air taken in from the front side of the vehicle flows to between the undercover 24 and the exhaust pipe 14.

In the fourth embodiment, when the grill shutter 80 and the outflow port shutter 58 are both set to the open state HS, a flow path in which the running air flows passing along the air guide path 84 from the grill 76 to between the undercover 24 and the exhaust pipe 14, is formed. As a result, the exhaust pipe 14, particularly the catalytic converter 20, can be effectively cooled.

In the fourth embodiment, it is also possible for the radiator fan 78 to be driven and a wind generated by the radiator fan 78 to be sent to between the undercover 24 and the exhaust pipe 14.

Note that in the third embodiment and the fourth embodiment, it is also possible to adopt a structure not having the outflow post 50 and the outflow port shutter 58.

In each of the above-described embodiments, it is also possible to adopt a structure not having the inflow port shatter 32 (including the grill shutter 80) or the outflow port shutter 58. In a structure not having, the inflow port shutter 32, it is possible for the running air to constantly be allowed to flow into between the exhaust pipe 14 and the undercover 24, during vehicle running. In a structure not having the outflow port shutter 58, it is possible for the running air to constantly be allowed to flow out to below the undercover 24 from between the exhaust pipe 14 and the undercover 24.

In contrast, when the inflow port shutter 32 or the outflow port shutter 58 are provided, these shutters should be set to the open state in the case of suppressing accumulation of heat of the exhaust pipe 54. Moreover, in the case it is not required to suppress accumulation of heat of the exhaust pipe 14, it is possible to increase flatness of the lower section of the vehicle by setting these shutters to the closed state.

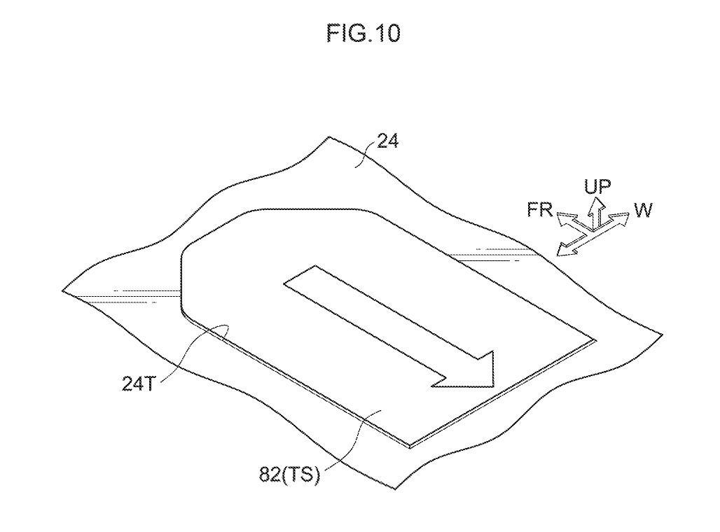

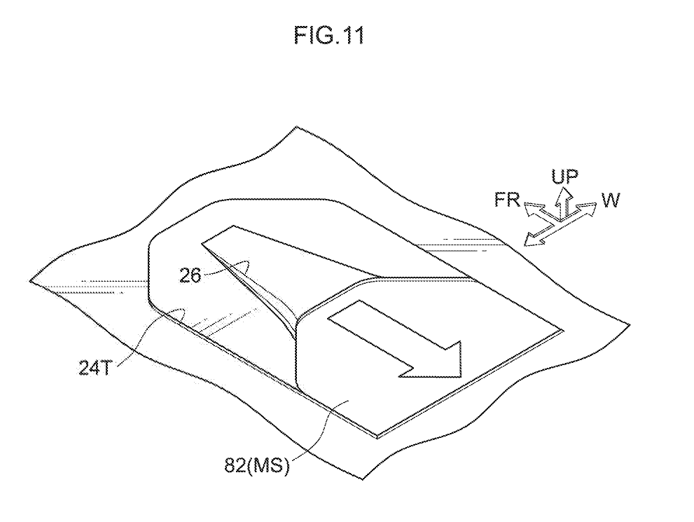

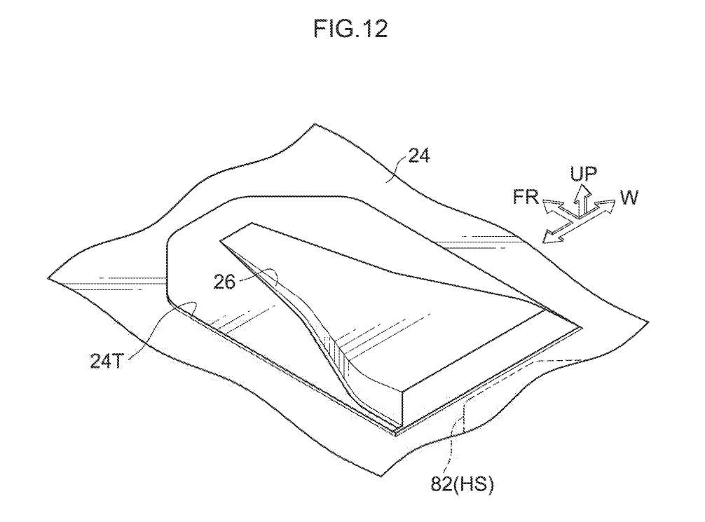

The inflow port shutter and the outflow port shutter are not limited to the above-described structure having the plurality of flaps 34. For example, it is possible to adopt a structure of a modified example shown in FIGS. 10 to 12. The structure of the modified example includes a plate-like opening/closing plate 82 that slides in the vehicle front-rear direction. This operating/closing plate 82 is slid in the vehicle front-rear direction by an unillustrated actuator. Moreover, the opening/closing plate 82 changes its state from a closed state TS shown in FIG. 10, via an intermediate state MS shown in FIG. 11, to an open state HS shown in FIG. 12 (and in an opposite direction). A recess 24T that has a shape corresponding to the opening/closing plate 82 in the closed state TS and recedes to an upper side, is formed in the undercover 24. By the opening/closing plate 82 in the closed state TS being fitted into the recess 24T, the lower surface of the undercover 24 and a lower surface of the opening/closing plate 82 become flush, and flatness of the lower surface of the undercover 24 increases.

A structure employing the likes of a motor or a solenoid was cited above as a specific structure of the drive device 36. However, the structure of the drive device 36 is not limited to this. For example, piping of the engine cooling water may be arranged such that heat of the engine cooling water acts on the drive device, and a drive device (thermoactuator) that exerts a drive force according to the temperature of the engine cooling water may be employed. In this structure, opening/closing of the inflow port shutter or the outflow port shutter can be controlled adopting the temperature of the engine cooling water as a control factor.

What is claimed is:

1. A vehicle lower structure comprising:
an exhaust pipe which is disposed below a floor panel of a vehicle and in which an exhaust from an engine flows;
an undercover that covers the exhaust pipe from below; and
an inflow port that allows running air to flow into between the exhaust pipe and the undercover.

2. The vehicle lower structure according to claim 1, wherein
the inflow port is formed in the undercover.

3. The vehicle lower structure according to claim 2, wherein:
a catalytic converter that is configured to clean the exhaust gas is provided in the exhaust pipe; and
the inflow port is formed under the catalytic converter or more to a front side of the vehicle than the catalytic converter.

4. The vehicle lower structure according to claim 1, further comprising an inflow port shutter that is configured to open/close the inflow port.

5. The vehicle lower structure according to claim 1, further comprising
an outflow port which is formed in the undercover on a side more to a rear of the vehicle than the inflow port and which allows the running air to flow out from between the undercover and the exhaust pipe to below the undercover.

6. The vehicle lower structure according to claim 5, further comprising an outflow port shutter that is configured to open/close the outflow port.

7. The vehicle lower structure according to claim 1, further comprising:
an inflow port shutter that is configured to open/close the inflow port;
an outflow port which is formed in the undercover on a side more to a rear of the vehicle than the inflow port and which allows the running air to flow out from between the undercover and the exhaust pipe to below the undercover; and
an outflow port shutter that is configured to open/close the outflow port in linkage with opening/closing of the inflow port by the inflow port shutter.

8. The vehicle lower structure according to claim 1, wherein
the undercover has a flat plate shape.

10. The vehicle lower structure according to claim 1, wherein
the inflow port has a substantially trapezoidal shape when viewed from below, and a width of the inflow port gradually increases from a front side to a rear side of the vehicle.
